(19) United States
(12) Patent Application Publication
(10) Pub. No.: US 2019/0196746 A1
(43) Pub. Date: Jun. 27, 2019

(54) INFORMATION PROCESSING DEVICE AND METHOD

(71) Applicant: Hitachi, Ltd., Chiyoda-ku, Tokyo (JP)

(72) Inventors: Kazuhisa FUJIMOTO, Tokyo (JP); Koji HOSOGI, Tokyo (JP); Toshiyuki ARITSUKA, Tokyo (JP); Kazushi NAKAGAWA, Tokyo (JP)

(21) Appl. No.: 16/329,639

(22) PCT Filed: Mar. 30, 2017
(86) PCT No.: PCT/JP2017/013294

§ 371 Date: Feb. 28, 2019

(51) Int. Cl. G06F 3/06; G06F 13/16

(52) U.S. Cl. CPC G06F 3/0661; G06F 13/1668; G06F 3/0673; G06F 3/0608

(57) ABSTRACT

An information processing device and a method having high processing performance are proposed. Provided is an information processing device mounted with an accelerator that executes predetermined processing on data, the information processing device including: a storage device configured to store data; and a host control unit configured to request the accelerator to execute the predetermined processing included in a task requested from an outside, in which the data is compressed and stored in the storage device, and in which the accelerator: reads the data to be processed among the data stored in the storage device and executes the predetermined processing on the data while decompressing the read data in response to a request from the host control unit.

### TECHNICAL FIELD

The present invention relates to an information processing device and a method, and is suitable for, for example, application to an analysis system for analyzing big data.

### BACKGROUND ART

Recently, big data analysis has become widespread in business sites, and the amount of data to be analyzed is steadily increasing. For example, commodity sales data (point of sale (POS) data) has an increasing data amount due to globalization of business and diversification of sales forms such as sales in both real and online stores. Such sales data is expected to be in the order of Terra Byte (TB) or more in the future.

In order to rapidly make use of an analysis result of big data in business determination, it is necessary to speed up the analysis processing and to output the result in a short time. However, with a limit of refinement of semiconductor processing, improvement in performance of a central processing unit (CPU) that executes analysis processing in an analysis device is predicted to be slow.

With an increase in the data amount and a performance limit of CPU, a lot of time is required for one analysis processing. More time is required if a plurality of analysis methods are applied to one database, or analysis processing is executed to a large number of databases.

Currently, as a method for solving such a problem, a method is known in which a part of an analysis processing executed by a CPU is offloaded to an accelerator mounted with a field programmable gate array (FPGA). The FPGA is an integrated circuit (LSI: Large Scale Integration) that can be freely programmed by a user.

However, in a case where the analysis processing is executed by either a CPU or an accelerator, if the data amount is large when the CPU or the accelerator reads the data to be processed from a storage device, a network band between the CPU or the accelerator and the storage device becomes a bottleneck, which delays the processing performed by the system as a whole.

For this reason, in a related analysis device performing analysis processing by only a CPU, a decompression circuit is arranged close to the CPU, compressed data stored in a storage device is decompressed in the decompression circuit and then stored in a main storage device (memory), and then the data is processed by the CPU (see PTL 1).

### PRIOR ART LITERATURE

### Patent Literature

PTL 1: W02015/181902

### SUMMARY OF INVENTION

### Technical Problem

However, in an accelerator mounted with an FPGA, a capacity of a mounted memory and a band thereof are limited. For this reason, in a case where a part of analysis processing executed by a CPU is offloaded to the FPGA, there is a problem that when decompressed data is stored in a memory mounted on such accelerator, the capacity of the memory or a band of a memory channel connected to the FPGA becomes a bottleneck, which delays processing performed by the system as a whole.

The invention has been made in view of the above circumstances, and an object of the invention is to propose an information processing device and method having high processing performances capable of transferring a large amount of data to an accelerator at a high speed and eliminating a bottleneck of a memory capacity or a memory channel band in the accelerator.

### Solution to Problem

In order to solve such a problem, an embodiment of the invention provides an information processing device mounted with an accelerator that executes predetermined processing on data, the information processing device including: a storage device configured to store data; and a host control unit configured to request the accelerator to execute the predetermined processing included in a task requested from an outside, in which the data is compressed and stored in the storage device, and in which the accelerator: reads the data to be processed among the data stored in the storage device and executes the predetermined processing on the data while decompressing the read data in response to a request from the host control unit.

An embodiment of the invention provides an information processing method executed on an information processing device mounted with an accelerator that executes predetermined processing on data, the information processing device including: a storage device configured to store data; and a host control unit configured to request the accelerator to execute the predetermined processing included in a task requested from an outside, the information processing method including: a first step of compressing and storing in the storage device the data; and a second step of, by the accelerator, reading the data to be processed among the data stored in the storage device and executing the predetermined processing on the data while decompressing the read data in response to a request from the host control unit.

An embodiment of the invention provides an information processing device including: a storage device configured to store data; an accelerator configured to execute predetermined processing on data; and a host control unit configured to request the accelerator to execute the predetermined processing included in a task requested from an outside, in which the data is compressed and stored in the storage device, in which the accelerator includes: an input/output circuit configured to input and output data from and to the accelerator; a decompression circuit configured to decompress the compressed data; a processing circuit configured to execute the predetermined processing; and a memory configured to store data, in which the input/output circuit reads the data to be processed from the storage device and stores the data in the memory in response to a request from the host control unit, in which the decompression circuit decompresses and transfers to the processing circuit the data to be processed stored in the memory, in which the processing circuit executes the predetermined processing on the decompressed data transferred from the decompression circuit, and stores a processing result of the predetermined processing in the memory, and in which the input/output circuit transmits the processing result of the predetermined processing stored in the memory to the host control unit.

According to the information processing device and the method of the invention, since compressed data is transferred from a storage device to an accelerator, an amount of data transferred from a storage device to the accelerator is smaller, and a possibility that a network band between the storage device and the accelerator becomes a bottleneck, which delays the processing, can be reduced. Moreover, according to the present information processing device and method, since the processing is performed on the data in the accelerator while decompressing the data, a capacity of a memory inside the accelerator and a bandwidth of a memory channel are not pressured due to the decompressed data, and it is possible to effectively avoid occurrence of such situation that the capacity of the memory and the bandwidth of the memory channel become a bottleneck, which delays the processing.

### Advantageous Effect

According to the invention, it is possible to realize an information processing device and a method having high processing performance.

### BRIEF DESCRIPTION OF DRAWINGS

FIG. 1 is a block diagram illustrating an overall configuration of an information processing system according to a first and a second embodiments.

FIG. 2 is a block diagram illustrating a hardware configuration of an accelerator.

FIG. 3 is a block diagram illustrating a software configuration and a data configuration in a main storage device.

FIG. 4 is a table showing a configuration example of a file storage location management table.

FIG. 5 is a table showing a configuration example of a compression information management table.

FIG. 6 is a block diagram for illustrating a schematic flow of processing such as filter processing executed in the worker node server according to the first embodiment.

FIG. 7 is a sequence diagram for illustrating a more detailed flow of filter processing and aggregation processing executed in the worker node server according to the first embodiment.

FIG. 8 is a conceptual diagram showing a configuration example of a processing command according to the first embodiment.

FIG. 9 is a sequence diagram for illustrating generation processing of a processing command.

FIG. 10 is a table showing a configuration example of an LBA list.

FIG. 11 is a block diagram for illustrating a schematic flow of processing such as filter processing executed in the worker node server according to the second embodiment.

FIG. 12 is a sequence diagram for illustrating a more detailed flow of filter processing and aggregation processing executed in the worker node server according to the second embodiment.

FIG. 13 is a conceptual diagram showing a configuration example of a processing command according to the second embodiment.

FIG. 14 is a conceptual diagram showing a configuration example of compression information.

### DESCRIPTION OF EMBODIMENTS

An embodiment of the invention will be described in detail below.

### (1) First Embodiment

### (1-1) Configuration of Information Processing System According to Present Embodiment

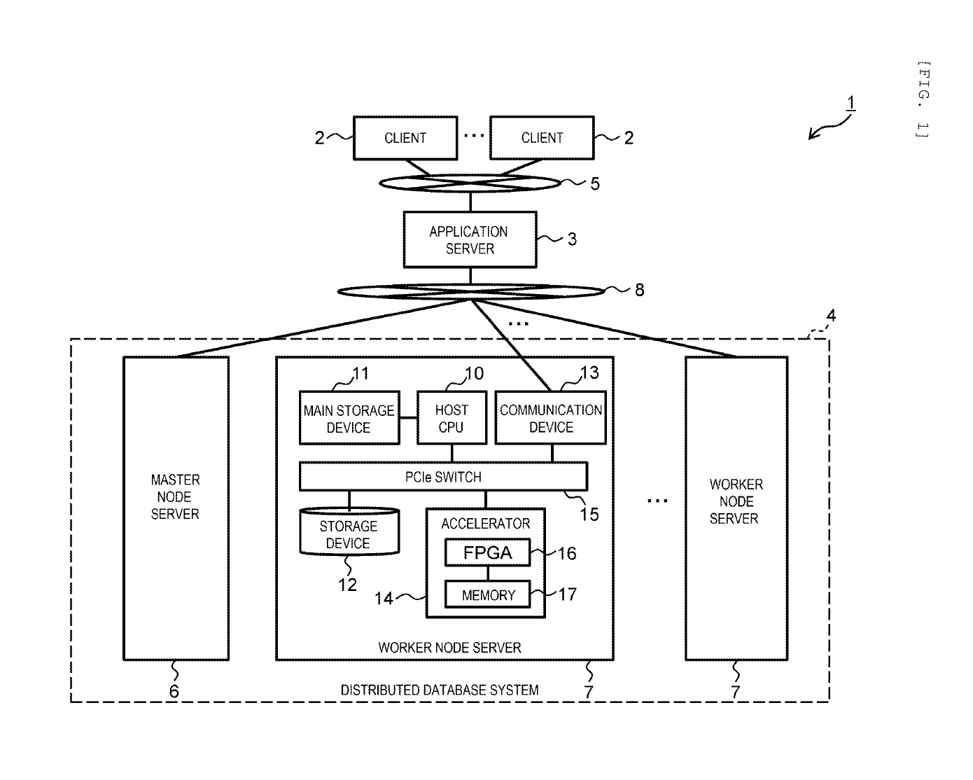

In FIG. 1, reference sign 1 denotes an information processing system according to the present embodiment as a whole. The information processing system 1 is an analysis system for analyzing big data.

In practice, the information processing system 1 includes one or a plurality of clients 2, an application server 3, and a distributed database system 4. Each client 2 is connected to the application server 3 via a first network 5 including a local area network (LAN), the Internet, or the like.

The distributed database system 4 includes a master node server 6 and a plurality of worker node servers 7, and these master node server 6 and worker node servers 7 are respectively connected to the application server 3 via a second network 8 including an LAN or the like.

The client 2 is a general-purpose computer device used by a user. In response to a user operation or a request from an application implemented on the client 2, the client 2 transmits a big data analysis request to the application server 3 via the first network 5. The client 2 displays the analysis result transmitted from the application server 3 via the first network 5.

The application server 3 includes a general-purpose server device on which an analysis business intelligence (BI) tool is implemented. The application server 3 generates a structured query language (SQL) query for acquiring data necessary for executing analysis processing requested by the client 2, and transmits the generated SQL query to the master node server 6 of the distributed database system 4. The application server 3 executes the analysis processing on the basis of a processing result of the SQL query transmitted from the master node server 6, and transmits an analysis result thereof to the client 2.

The master node server 6 is, for example, a general-purpose server device functioning as a master node on Hadoop. In practice, the master node server 6 analyzes the SQL query transmitted from the application server 3 via the second network 8, and decomposes the processing on the basis of the SQL query into a plurality of tasks. The master node server 6 creates an execution plan of these tasks and transmits execution requests of these tasks (hereinafter, referred to as “task execution requests”) to respective worker node servers 7 in accordance with the created execution plan. Then, the master node server 6 transmits an execution result of these task execution requests transmitted from respective worker node servers 7 to the application server 3 as a processing result of the SQL query.

The worker node servers 7 are, for example, general-purpose server devices functioning as worker nodes on Hadoop. In practice, each worker node server 7 holds a part of data of a database distributed and arranged in the distributed database system 4 in a storage device 12 to be described later, executes necessary processing in accordance with the task execution request given from the master node server 6, and transmits a processing result thereof to another worker node server 7 or the master node server 6.

Each worker node server 7 includes a host central processing unit (CPU) 10, a main storage device 11, one or a plurality of storage devices 12, a communication device 13, and an accelerator 14. The host CPU 10, the storage device 12, the communication device 13, and the accelerator 14 are connected to one another via a peripheral component interconnect express (PCIe) switch 15.

The host CPU 10 is a processor governing overall operation control of the worker node servers 7. The host CPU 10 executes the tasks instructed in the task execution requests transmitted from the master node server 6 on the basis of a software stored in the main storage device 11 to be described later, and notifies the master node server 6 of an execution result thereof. At this time, in a case where the tasks include a filter processing, or a filter processing and an aggregation processing (hereinafter, referred to as “the filter processing, etc.”), the host CPU 10 causes the accelerator 14 to perform the filter processing, etc. by transmitting a corresponding processing command to the accelerator.

The main storage device 11 includes, for example, a volatile semiconductor memory, and is used for temporarily storing various software and various data loaded from the storage device 12. By executing the software stored in the main storage device 11 with the host CPU 10, various processing to be described later is executed by the worker node servers 7 as a whole.

The storage device 12 includes, for example, a large-capacity nonvolatile storage device such as a hard disk device or a solid state drive (SSD). In the storage device 12, data of a part of tables of a database distributed and arranged in the distributed database system 4 is converted into one or more files and stored as database data. In the following description, it is assumed that the storage device 12 is an SSD, and each file in which the database data is stored is compressed by the host CPU 10 and stored in the storage device 12.

The communication device 13 includes, for example, a network interface card (NIC), and functions as an interface for performing protocol control during communication with the master node server 6 and the application server 3 via the second network 8.

The accelerator 14 includes a field programmable gate array (FPGA) 16 and a memory 17. The FPGA 16 executes filter processing, etc. in accordance with a processing command given from the host CPU 10, and transmits a processing result thereof to the host CPU 10. The memory 17 includes, for example, a dynamic random access memory (DRAM), and is used as a work memory of the FPGA 16.

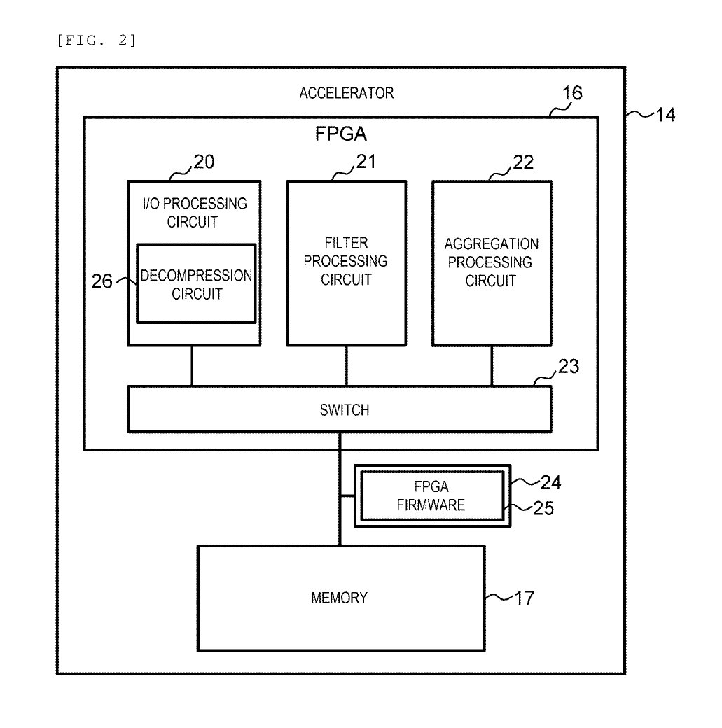

FIG. 2 illustrates a detailed configuration of the FPGA 16. As illustrated in FIG. 2, the FPGA 16 includes an input/output (I/O) processing circuit 20, a filter processing circuit 21, and an aggregation processing circuit 22 connected to one another via a switch 23.

The I/O processing circuit 20 is an input/output circuit having a function of reading an FPGA firmware 25 stored in an ROM 24 upon initiation of the accelerator 14 and executing necessary I/O processing on the basis of the read FPGA firmware 25, and includes a decompression circuit 26 therein.

In practice, the I/O processing circuit 20 analyzes the above-described processing command transmitted from the host CPU 10 via the PCIe switch 15 (FIG. 1), reads files of the database data to be processed by the requested filter processing, etc. from the storage device 12 (FIG. 1), stores the files in the memory 17, and instructs the filter processing circuit 21 or both the filter processing circuit 21 and the aggregation processing circuit 22 to execute necessary processing via the switch 23. At this time, the I/O processing circuit 20 transmits the compressed database data read from the storage device 12 to the memory 17 into the filter processing circuit 21 via the switch 23 while decompressing the compressed database data in the decompression circuit 26. The I/O processing circuit 20 transmits, to the host CPU 10 (FIG. 1), a processing result of the filter processing and/or the aggregation processing executed by the filter processing circuit 21 and/or the aggregation processing circuit 22 as a result of executing the processing command.

The filter processing circuit 21 is a circuit having a function of executing filter processing in accordance with an instruction given from the I/O processing circuit 20 on the decompressed database data given from the I/O processing circuit 20. The filter processing is a process of comparing a conditional expression specified by the SQL query with the target database data, and extracting only those matching the conditional expression. The filter processing circuit 21 stores a processing result of the filter processing in the memory 17 via the switch 23 in a case where a content of such processing command is only the filter processing, and transmits the processing result of the filtering processing to the aggregation processing circuit 22 in a case where the content of the processing command is the filter processing and the aggregation processing.

The aggregation processing circuit 22 is a circuit having a function of performing a required aggregation processing such as calculating an average value or a total value, or extracting a maximum value or a minimum value, with respect to the data extracted in the filter processing given from the filter processing circuit 21. The aggregation processing circuit 22 stores a processing result of such aggregation processing in the memory 17 via the switch 23.

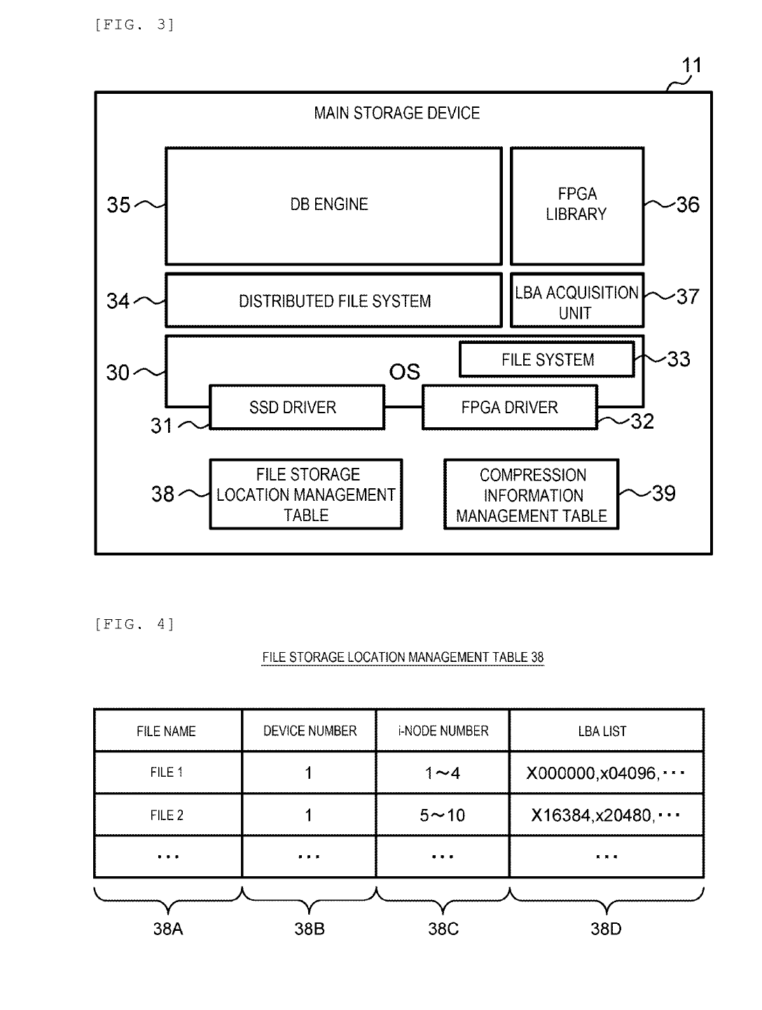

FIG. 3 illustrates a software configuration and a data configuration in the main storage device 11. An operating system (OS) 30 is stored in the main storage device 11, and the SSD driver 31 and the FPGA driver 32 operate on the OS 30. The SSD driver 31 is software having a function of controlling the storage device 12 (FIG. 1), and the FPGA driver 32 is software having a function of controlling the FPGA 16 (FIG. 2) of the accelerator 14 (FIG. 1).

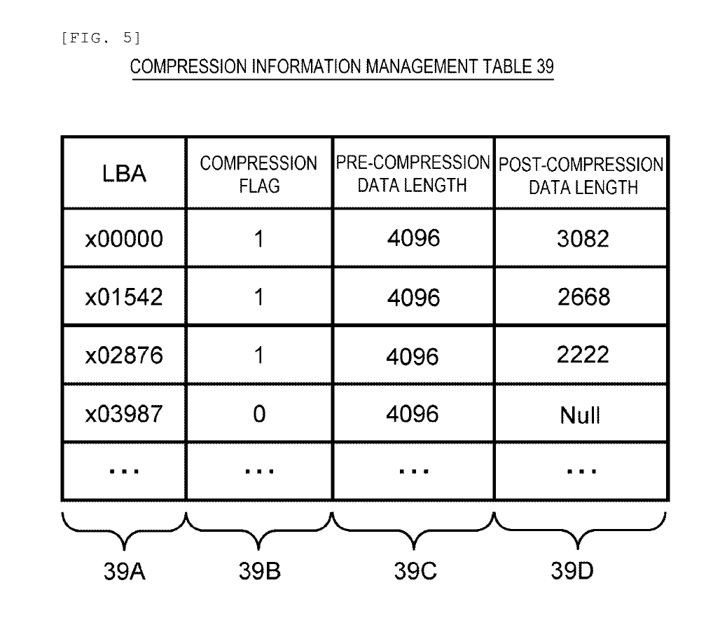

The OS 30 includes a file system 33 as a part of a function thereof. The file system 33 is a functional unit managing respective files of the database data stored in the storage device 12, and manages, for example, information indicating file names of respective files held by the worker node server 7 thereof, which logical blocks in which storage devices 12 the data of these files are stored, and whether the data of the files is compressed, by using a file storage position management table to be described later with reference to FIG. 4 and a compression information management table 39 to be described later with reference to FIG. 5.

The term “logical block” refers to a management unit of storage area provided by the storage device 12. The storage area provided by the storage device 12 is divided into small areas referred to as “logical blocks” of a predetermined size (for example, 4096 bytes), and addresses unique to the “logical blocks” referred to as “logical brock addresses” (LBA) are respectively assigned to these “logical blocks” and managed.

The main storage device 11 also stores a distributed file system 34, a database engine 35, an FPGA library 36, and an LBA acquisition unit 37. The distributed file system 34 is, for example, software functioning as a Hadoop distributed file system (HDFS) on Hadoop, and manages information indicating which database data (file) is held in which worker node server 7 in the distributed database system 4 (FIG. 1), etc.

The database engine 35 is software having a function of executing various processing (such as search, deletion, and update) on the database data stored in the storage device 12 in its own worker node server in response to the task execution request given from the master node server 6. In this case, in a case where a processing content of the task requested in the task execution request includes filter processing, etc., the database engine 35 requests the FPGA library 36 to execute the filter processing, etc. The database engine 35 transmits the execution result of the task specified in the task execution request to the master node server 6 or another worker node server 7.

The FPGA library 36 includes modules for communicating with the database engine 35, the FPGA driver 32, and the LBA acquisition unit 37, respectively. When execution of the filter processing, etc. is requested from the database engine 35, the FPGA library 36 acquires an identifier (device number) of the storage device 12 in which the file to be processed in the filter processing, etc. is stored from the file system 33 via the LBA acquisition unit 37, acquires the LBA of the logical block in the storage device 12 in which the data of the file is stored, and transmits the processing command to which the acquired information is added to the FPGA 16 (FIG. 1) of the accelerator 14 (FIG. 1) via the FPGA driver 32. Further, the FPGA library 36 notifies the database engine 35 of a processing result of the filtering processing, etc. on the basis of the processing command given from the FPGA 16 via the FPGA driver 32.

The LBA acquisition unit 37 is software having a function of inquiring the file system 33 about the identifier of the storage device 12 in which the data of the requested file is stored and the LBA of the logical block in the storage device 12 in which the data of the file is stored, in response to a request from the FPGA library 36. The LBA acquisition unit 37 notifies the FPGA library 36 of the identifier of the storage device 12 and the LBA obtained as a result of the inquiry.

A configuration example of the file storage location management table 38 managed by the file system 33 is shown in FIG. 4. The file storage position management table 38 is a table used for managing storage positions of respective files of the database data stored in the storage device 12 of the worker node server 7 thereof, and includes a file name column 38A, a device number column 38B, an i-node number column 38C, and an LBA list column 38D as shown in FIG. 4. In the file storage position management table 38, one record (row) corresponds to one file.

The file name column 38A stores file names of all the files stored in the storage device 12 of the worker node server 7 thereof. The device number column 38B stores an identifier (device number) of the storage device 12 in which the corresponding file is stored.

The i-node number column 38C stores identifiers (i-node numbers) unique to respective i-nodes which are respectively assigned to the i-nodes constituting the file thereof, and the LBA list column 38D stores LBAs of respective logical blocks, in which the data of respective i-nodes of the corresponding files is stored. Data of one i-node is stored in one logical block (one i-node number is associated with one LBA).

A configuration example of the compression information management table 39 managed by the file system 33 is shown in FIG. 5. The compression information management table 39 is a table used for managing whether or not the data stored in each logical block of the storage device 12 of the worker node server 7 thereof is compressed, and includes an LBA column 39A, a compression flag column 39B, a pre-compression data length column 39C, and a post-compression data length column 39D as shown in FIG. 5. In the compression information management table 39, one record (row) corresponds to one logical block.

The LBA column 39A stores LBAs of logical blocks, and the compression flag column 39B stores flags indicating whether or not the database data stored in the corresponding logical block is compressed (hereinafter, referred to as “compression flags”). In the present embodiment, the compression flag is set to “1” in a case where the data of the corresponding file is compressed and stored in the storage device 12, and is set to “0” in a case where the data is stored in the storage device 12 without being compressed.

In a case where the data stored in the corresponding logical block is compressed, the pre-compression data length column 39C stores the data length before compression of the data, and the post-compression data length column 39D stores the data length after compression of the data. In a case where the data stored in the corresponding logical block is not compressed, the post-compression data length column 39D stores “Null”, which indicates that no data is present.

### (1-2) Flow of Processing in Worker Node Server

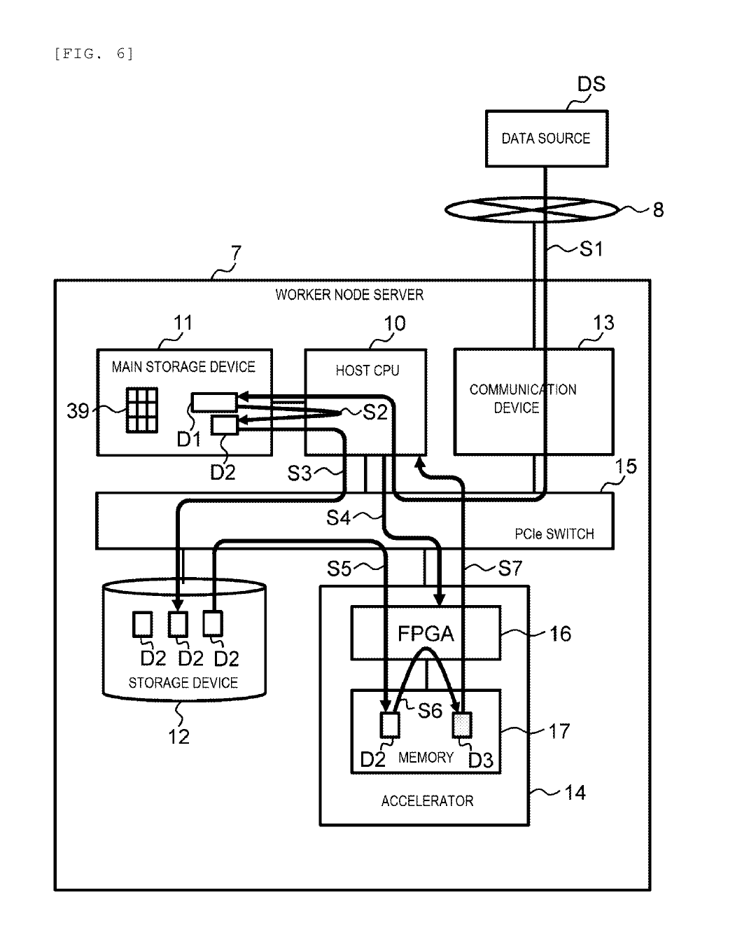

FIG. 6 illustrates a flow of a series of processing related to filter processing, etc. executed in the worker node server 7.

As illustrated in FIG. 6, data D1 of each file of the database data stored in the main storage device 11 is fetched from a predetermined data source DS by the communication device 13 via the second network 8, and is stored in the main storage device 11 via the PCIe switch 15 and the host CPU 10 (S1). Then, the data D1 is compressed by the host CPU 10 (S2) and then stored as compressed data D2 in the storage device 12 (S3).

The host CPU 10 stores the compressed data D2 in the storage device 12, and then stores in the file storage position management table 38 the file names, the device numbers of the storage devices 12 as storage destinations of the compressed data D2, and the LBAs of respective logical blocks as storage destinations of the compressed data D2 in the storage devices 12 of the respective files of the database data obtained by compressing the data D1 at this time, respectively. The host CPU 10 stores in the compression information management table 39 the LBAs, the compression flags indicating presence or absence of compression, and the data lengths before and after compression of the data D1 stored in the logical blocks of respective logical blocks storing such compressed data D2 in the storage devices 12.

Then, when the task execution request is given from the master node server 6 and the processing instructed by the task execution request is filter processing, etc., the host CPU 10 transmits a processing command corresponding to the task execution request to the FPGA 16 of the accelerator 14 via the PCIe switch 15 (S4).

Upon receipt of such processing command, the FPGA 16 reads the compressed data D2 of the file to be processed in the filter processing, etc. in accordance with the processing command from the storage device 12 into the memory 17 of the accelerator 14 (S5).

The FPGA 16 executes filter processing, etc. specified in the processing command while decompressing the compressed data D2 read into the memory 17, and stores data of a processing result thereof (hereinafter, referred to as “processing result data”) D3 in the memory 17 (S6). Then, the FPGA 16 reads the processing result data D3 from the memory 17 and transmits the read processing result data D3 to the host CPU 10 (S7).

Thereby, the host CPU 10 transmits the processing result data D3 thus obtained to the master node server 6 as a processing result of the task execution request.

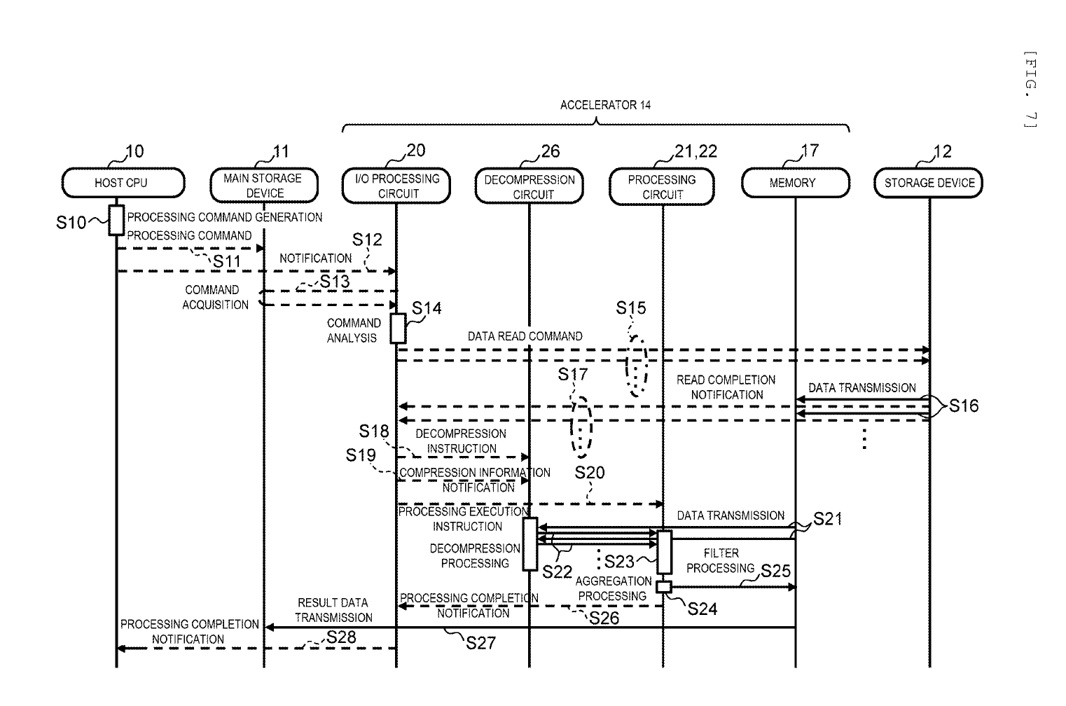

FIG. 7 illustrates a detailed processing flow of steps S4 to S7 in FIG. 6 described above. In FIG. 7, it is assumed that the content of the task requested in the task execution request given from the master node server 6 to the worker node server 7 is filter processing and aggregation processing.

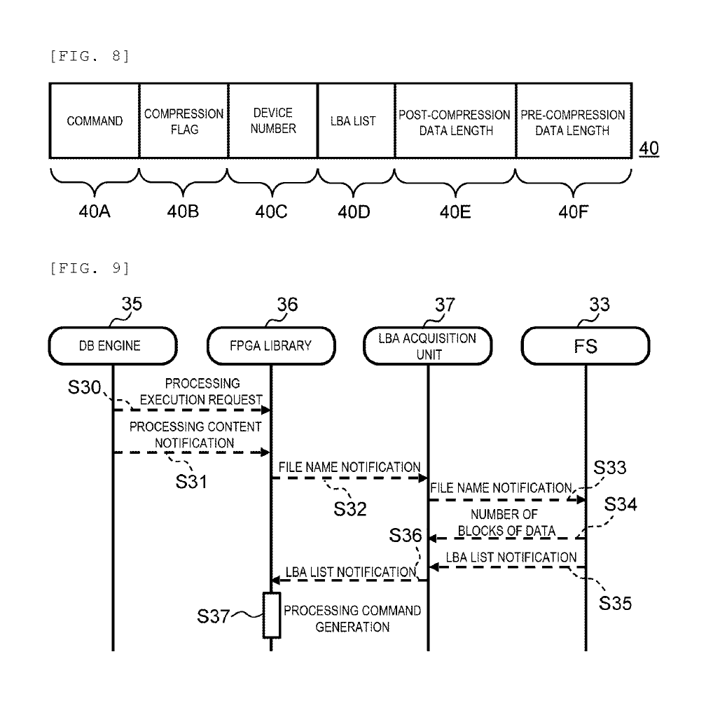

When such task execution request is given from the master node server 6, the host CPU 10 of the worker node server 7 generates a processing command 40 (FIG. 8) corresponding to the filter processing and the aggregation processing requested in the task execution request (S10).

As shown in FIG. 8, the processing command 40 has a command format including a command field 40A, a compression flag field 40B, a device number field 40C, an LBA list field 40D, a post-compression data length field 40E, and a pre-compression data length field 40F.

The command field 40A stores a specific content (including the file name of the file to be processed) of the filter processing, etc. requested in the task execution request. The compression flag field 40B stores a compression flag indicating whether or not the data (database data) of the file to be processed of the filter processing, etc. is compressed and stored in the storage device. The compression flag is set to “1” in a case where the data of the file to be processed is compressed and stored in the storage device 12, and is set to “0” in a case where the data of the file is stored in the storage device 12 without being compressed.

The device number field 40C stores the device number, which is the identifier of the storage device 12 in which data of the file to be processed of the filter processing, etc., and the LBA list field 40D stores the LBAs of all the logical blocks, in which the data of the file in the storage device 12 is stored. The post-compression data length field 40E stores the total data length after compression (post-compression data length) in a case where the data of the file is compressed, and the pre-compression data length field 40F stores the total data length before compression (pre-compression data length) of the data of the file.

The host CPU 10 acquires the device number and the LBA list in the processing command 40 described above by searching the file storage location management table 38 using the file name of the file to be processed specified in the task execution request as a key, and stores the same in the device number field 40C and the LBA list field 40D of the processing command 40. Then, with respect to the compression flag, the host CPU 10 determines whether or not the data stored in each LBA registered in the LBA list acquired from the file storage location management table 38 by referring to the compression flags stored in the corresponding compression flag column 39B of the compression information management table 39, and stores a compression flag having a value (“1” or “0”) corresponding to the determination result in the compression flag field 40B of the processing command 40.

Then, the host CPU 10 calculates the pre-compression data length as a sum of data lengths stored in pre-compression data length column 39C corresponding to respective logical blocks in which the data of the file to be processed is stored in the compression information management table 39 (FIG. 5), and stores a calculation result in the pre-compression data length field 40F of the processing command 40. Similarly, the host CPU 10 calculates the post-compression data length as a sum of the data lengths stored in the post-compression data length column 39D corresponding to respective logical blocks in which the data of the file to be processed is stored in the compression information management table 39 (FIG. 5), and stores a calculation result in the post-compression data length field 40E of the processing command 40.

The post-compression data length is used for securing, in the memory 17, storage areas of capacities necessary for the I/O processing circuit 20 of the accelerator 14 to store the data of the file to be processed read from the storage device 12, and for securing, in a memory disposed in the FPGA 16 (hereinafter referred to as an “in-FPGA memory”), which is not shown, storage areas for the decompression circuit 26 to read the data to be processed from the memory 17 into the in-FPGA memory. The pre-compression data length is used for securing, in the in-FPGA memory, storage areas for storing the decompressed data after the decompression circuit 26 decompresses the data read into the in-FPGA memory. The in-FPGA memory is connected to the switch 23, and read and write of data from/to the in-FPGA memory performed by the decompression circuit 26, the filter processing circuit 21, and the aggregation processing circuit 22 is performed via the switch 23. The in-FPGA memory may be directly connected to two related circuits.

Referring back to FIG. 7, when generating the processing command 40 as described above in step S10, the host CPU 10 stores the generated processing command 40 in the main storage device 11 (S11), and transmits a notification indicating that such processing command 40 is stored in the main storage device 11 (hereinafter, referred to as a “processing command storage notification”) to the I/O processing circuit 20 of the FPGA 16 (FIG. 2) of the accelerator 14 (S12).

When given such processing command storage notification, the I/O processing circuit 20 reads the above-described processing command 40 from the main storage device 11 (S13), and analyzes a content of the command stored in the command field 40A of the read processing command 40 (S14). At this time, the I/O processing circuit 20 specifies the file name of the file to be subjected to the filter processing and the aggregation processing instructed by the processing command 40, and acquires the LBAs of respective logical blocks in which the data of the file is stored from the LBA list column 38D (FIG. 4) of a record (row) in which the file name of the file is stored in the file name column 38A (FIG. 4) of the file storage position management table 38 (FIG. 4).

Subsequently, the I/O processing circuit 20 sequentially generates data read commands for respective logical blocks in which the data of the file to be processed is stored, whose LBAs have been obtained in step S14, and sequentially transmits the generated data read commands to the storage device 12 to which the device number stored in the device number field 40C (FIG. 8) of the processing command 40 is assigned (S15). At this time, before transmitting the generated data read commands to the storage device 12, the I/O processing circuit 20 refers to the pre-compression data length column 39C (FIG. 5) of records (rows) in which the LBAs of the logical blocks corresponding to the data read commands are stored in the LBA column 39A in the compression information management table 39 (FIG. 5), secures, in the memory 17, storage areas having the same capacities as the data lengths stored in the pre-compression data length column 39C, and stores addresses of the storage areas in the data read commands.

Every time a data read command is transmitted, the storage device 12 reads data from the logical block specified in the data read command, and writes the read data in the storage areas specified in the data read command in the memory 17 of the accelerator 14 (S16). At this time, each time data stored in one logical block is written in the memory 17 of the accelerator 14, the storage device 12 transmits a read completion notification to the I/O processing circuit 20 (S17).

When all of the data of the file to be processed is transferred from the storage device 12 to the memory 17, the I/O processing circuit 20 gives an instruction to the decompression circuit 26 so as to decompress the data (hereinafter, referred to as a “decompression instruction”) (S18). In addition to this, the I/O processing circuit 20 notifies the decompression circuit 26 of the data lengths before and after compression of the file to be processed, so as to secure, in the in-FPGA memory, storage areas of capacities necessary for the decompression circuit 26 to perform the decompression processing (S19).

Then, the I/O processing circuit 20 transmits to the filter processing circuit 21 and the aggregation processing circuit 22 an instruction of executing filter processing and aggregation processing specified in the processing command 40 from the host CPU 10 (hereinafter, referred to as a “processing execution instruction”) (S20).

Thus, the decompression circuit 26, to which the decompression instruction of step S18 is given, sequentially fetches the data of the file to be processed transferred to the memory 17 by a predetermined unit (S21), decompresses the fetched data, and then passes the same to the filter processing circuit 21 via the in-FPGA memory (S22).

The filter processing circuit 21 executes the filter processing instructed from the I/O processing circuit 20 to the data passed from the decompression circuit 26 (decompressed data of the file to be processed), and transmits a processing result to the aggregation processing circuit 22 via the switch 23 (FIG. 2) (S23).

Then, the aggregation processing circuit 22 executes the aggregation processing instructed from the I/O processing circuit 20 to the filtered data (database data) supplied from the filter processing circuit 21 (S24), and stores a processing result in the memory 17 (S25). When the aggregation processing is completed, the aggregation processing circuit 22 transmits a processing completion notification to the I/O processing circuit 20 (S26).

Upon receipt of such process completion notification, the I/O processing circuit 20 reads the processing result of the aggregation processing stored in the memory 17, transfers the same to the main storage device 11 via the PCIe switch 15 (FIG. 1) (S27), and transmits a processing completion notification to the host CPU 10 (S28).

After receiving such process completion notification, the host CPU 10 reads the processing result of the aggregation processing stored in the main storage device 11, and transmits the same to the master node server 6.

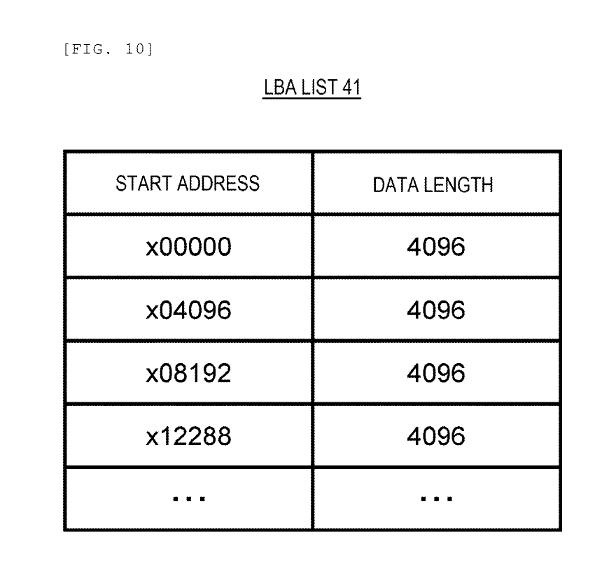

Here, specific processing content of generation processing of the processing command 40 executed by the host CPU 10 in step S10 of the series of processing described above with reference to FIG. 7 will be described with reference to FIG. 9 as a flow of processing between each software described above with reference to FIG. 3.

In the following description, a processing subject of each processing will be described as “software”, but it is needless to say that in practice, the host CPU 10 executes the processing on the basis of the “software”. Exchange of commands and data between the database engine 35, the FPGA library 36, the LBA acquisition unit 37, and the file system 33 is performed via the main storage device 11, but the description will be given below with the main storage device 11 omitted.

When a task execution request including filter processing and aggregation processing as tasks is given from the master node server 6 to the worker node server 7, a series of processing illustrated in FIG. 9 is started, and first, the database engine 35 requests the FPGA library 36 to execute the filter processing and the aggregation processing (S30). The database engine 35 further notifies the FPGA library 36 of a specific content of the filter processing and the aggregation processing instructed in such task execution request (including the file name of the file to be processed) (S31).

When notified of such processing content from the database engine 35, the FPGA library 36 notifies the LBA acquisition unit 37 of the file name of the file to be processed (S32). When notified of such file name, the LBA acquisition unit 37 notifies the file system 33 of the file name (S33).

When notified of such file name, the file system. 33 refers to the file storage position management table 38 (FIG. 4), and acquires the identifier (device number) of the storage device 12 in which the data of the file of the file name is stored and the number of blocks of the logical blocks in which the data of the file in the storage device 12 is stored. Specifically, the file system 33 acquires the device number stored in the device number column 38B (FIG. 4) of a record (row) in which the file name is stored in the file name column 38A (FIG. 4) in the file storage position management table 38 (FIG. 4), and counts a number of LBAs stored in the LBA list column 38D of the record, so as to acquire the number of blocks. Then, the file system 33 notifies the LBA acquisition unit 37 of the device number and the number of blocks thus acquired (S34).

Further, the file system 33 refers to the file storage position management table 38 (FIG. 4) and the compression information management table 39 to generate an LBA list 41 as shown in FIG. 10 and notifies the LBA acquisition unit 37 of the LBA list 41 (S35).

Specifically, the file system 33 reads all the LBAs stored in the LBA list column 38D of the record (row) corresponding to the file name notified from the FPGA library 36 in step S33 in the file storage position management table 38. The file system 33 reads the data lengths stored in the pre-compression data length column 39C of the records in which the read LBAs are stored in the LBA column 39A (FIG. 5) in the compression information management table 39 for the respective LBAs, and generates the LBA list 41 in FIG. 10 in which the LBAs and the data lengths are respectively associated with one another. Then, the file system 33 notifies the LBA acquisition unit 37 of the LBA list 41 thus generated.

Upon receipt of the LBA list 41, the LBA acquisition unit 37 notifies the FPGA library 36 of the LBA list 41 (S36).

Upon receipt of the LBA list 41, the FPGA library 36 generates the processing command 40 described above with reference to FIG. 8 on the basis of the LBA list 41, the file storage position management table 38 (FIG. 4), and the compression information management table 39 (FIG. 5) (S37). Thus, processing of step S10 of FIG. 7 is ended.

### (1-3) Effects of the Present Embodiment

As described above, in the present embodiment, in the worker node server 7, the compressed data stored in the storage device 12 is transferred to the accelerator 14 in a compressed state, and the accelerator 14 performs filter processing, etc. to the data while decompressing the data.

Therefore, according to the present embodiment, since the data is compressed and transferred between the storage device 12 and the accelerator 14, the amount of transferred data is smaller, and a possibility that a network band between the storage device 12 and the accelerator 14 becomes a bottleneck, which delays the processing, can be reduced accordingly. Further, according to the present embodiment, since the filter processing and the aggregation processing are executed in the filter processing circuit 21 and the aggregation processing circuit 22 while decompressing the data without the memory 17 therebetween in the accelerator 14, the compressed data does not need to be stored in the memory 17, and accordingly, it is possible to effectively avoid occurrence of a situation that the memory capacity in the accelerator 14 or the bandwidth of the memory channel becomes a bottleneck, which delays the processing. Therefore, according to the present embodiment, a worker node server 7 having high processing performance can be realized.

### (2) Second Embodiment

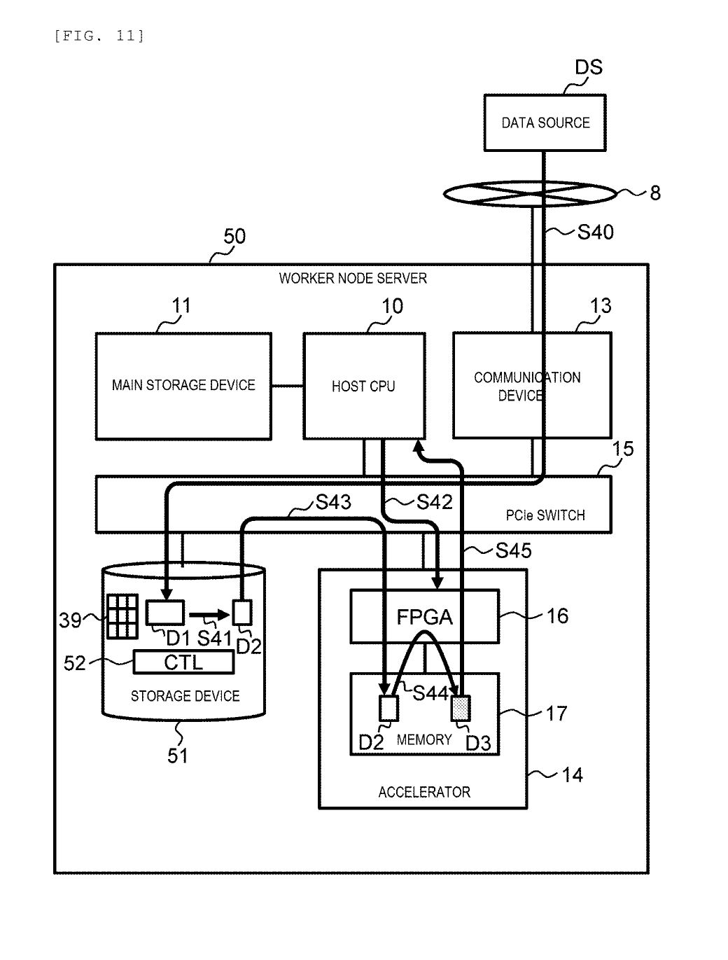

FIG. 11, whose parts corresponding to FIG. 1 are denoted by the same reference numerals, illustrates a worker node server 50 according to a second embodiment applied to the information processing system 1 in FIG. 1 instead of the worker node server 7 according to the first embodiment.

The worker node server 50 is configured similarly as the worker node server 7 according to the first embodiment except that the data D1 of each file of the database data fetched from the data source DS is compressed in the storage device 51, and as a result, the compression information management table 39 is stored in a storage device 51 instead of in the main storage device 11.

In practice, in the worker node server 50 of the present embodiment, as illustrated in FIG. 11, the data D1 of each file in which the database data is stored is fetched from the predetermined data source DS by the communication device 13 via the second network 8 and stored in the storage device 51 via the PCIe switch 15 (S40).

The storage device 51 includes a storage device (the SSD as described above as for the present embodiment) providing a storage region, and a controller 52 controlling read and write of data from and to the storage device. The controller 52 is configured as a microcomputer including an information processing resource such as a CPU and a memory. When the data D1 of each file is written from the communication device 13, the controller 52 compresses the data D1 and writes the compressed data D2 thus obtained into the SSD in the storage device 51 (S41).

At this time, the controller 52 writes information such as the LBAs of the logical blocks on the storage device in which the data D1 is written, presence or absence of compression, and the data lengths before and after compression of the data, in the compression information management table 39 (FIG. 1). The controller 52 notifies the host CPU 10 of the LBAs of the respective logical blocks on the storage device and the device number of the storage device 51 in which the data D1 is written via the PCIe switch 15.

On the other hand, in a case where a task execution request is given from the master node server 6 and the processing instructed by the task execution request is filter processing, etc., the host CPU 10 transmits a processing command corresponding to the task execution request to the FPGA 16 of the accelerator 14 via the PCIe switch 15 (S42).

Upon receipt of such processing command 40, the FPGA 16 reads the compressed data D2 of the file to be processed in the filter processing, etc. in accordance with the processing command from the storage device 51 into the memory 17 of the accelerator 14 (S43).

The FPGA 16 executes the filter processing, etc. specified in the processing command while decompressing the compressed data D2 read into the memory 17, and stores the processing result data D3 thus obtained in the memory 17 (S44). Then, the FPGA 16 reads the processing result data D3 from the memory 17 and transmits the read processing result data D3 to the host CPU 10 (S45).

Thereby, the host CPU 10 transmits the processing result data D3 thus obtained to the master node server 6 as a processing result of the task execution request.

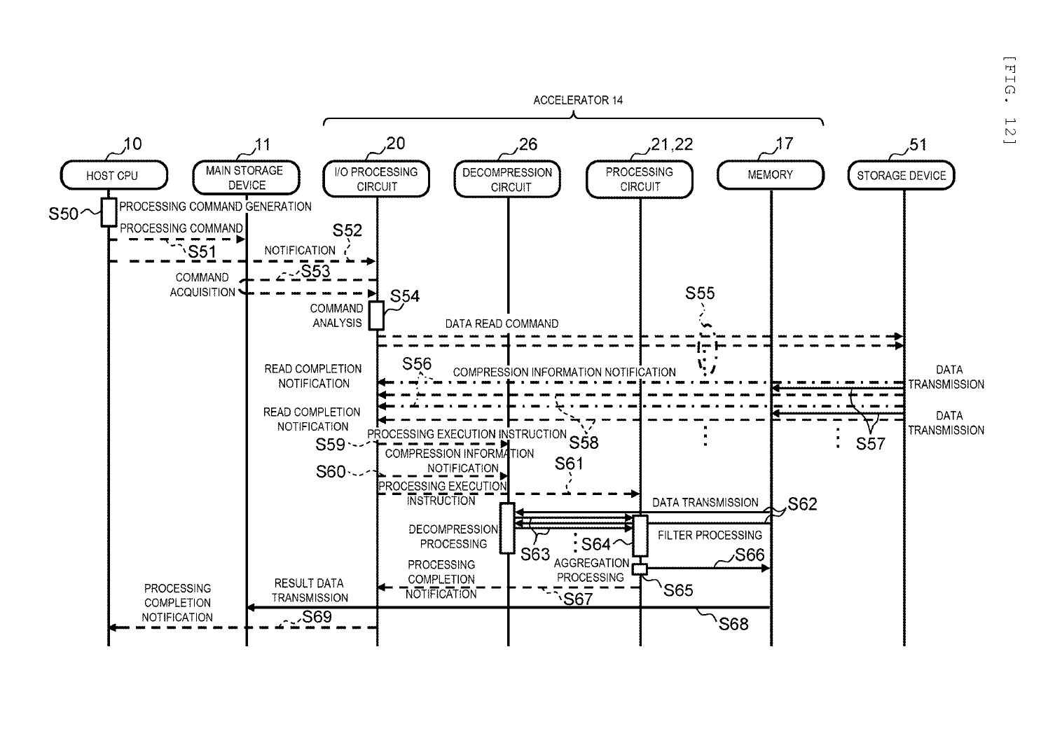

FIG. 12 illustrates a detailed processing flow of steps S42 to S45 in FIG. 11 described above. In FIG. 12, it is assumed that the content of the task instructed in the task execution request given from the master node server 6 to the worker node server 50 is filter processing and aggregation processing.

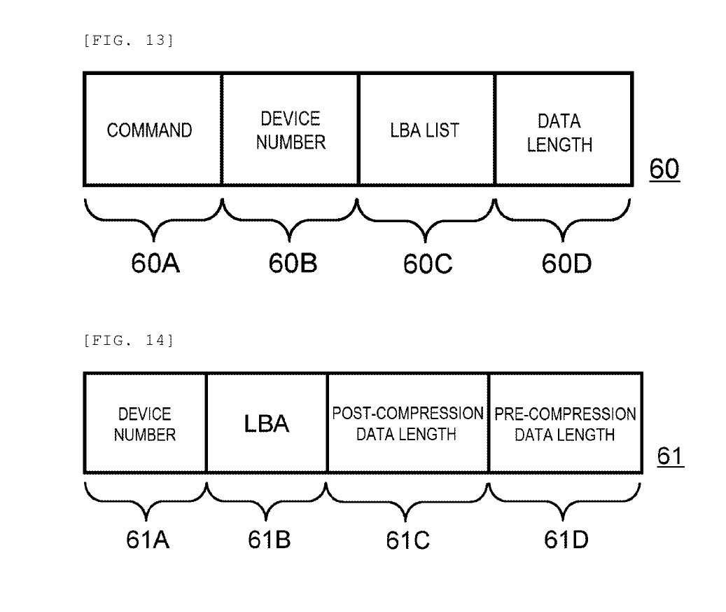

When such task execution request is given from the master node server 6, the host CPU 10 of the worker node server 50 generates a processing command 60 (FIG. 13) corresponding to the filter processing and the aggregation processing instructed in the task execution request (S50).

As shown in FIG. 13, the processing command 60 has a command format including a command field 60A, a device number field 60B, an LBA list field 60C, and a data length field 60D.

The command field 60A stores the specific content of the filter processing, etc. instructed in the task execution request, and the device number field 60B stores the device number, which is the identifier of the storage device 51 in which data of the file to be processed of the filter processing, etc. is stored.

The LBA list field 60C stores the LBAs of all the logical blocks, in which the data of the file in the storage device 51 is stored, and the data length field 60D stores the data length of the data before the compression of the file.

The host CPU 10 acquires the device number and the LBA list in the processing command 60 described above by searching the file storage location management table 38 (FIG. 4) using the file name of the file to be processed specified in the task execution request as a key, and stores the same in the device number field 60B and the LBA list field 60C of the processing command 60. The host CPU 10, with respect to a data length, stores a multiplication result obtained by multiplying the number of LBAs (the number of logical blocks) registered in such LBA list by a block length of one logical block (4096 bytes) in the data length field 60D.

A difference between the processing command 60 and the processing command 40 (FIG. 8) of the first embodiment is that the processing command 60 of the present embodiment does not include information of the compression flag and the data length before and after compression of the file to be processed (pre-compression data length and post-compression data length).

This is because that in the case of the present embodiment, the data of each file is compressed in the storage device 51 as described above, and accordingly, the compression information management table 39 is also stored in the storage device 51 without being stored in the main storage device 11, so that the host CPU 10 does not hold information on compression of the data of each file.

Then, in the worker node server 50 of the present embodiment, processing similar as steps S11 to S15 in FIG. 7 are executed in steps S51 to S55.

The controller 52 of the storage device 51 notifies the I/O processing circuit 20 of compression information 61 as shown in FIG. 14 each time the data read command for each logical block in which the compressed data (compressed database data) of the file to be processed is stored is given from the I/O processing circuit 20 in step S55 (S56).

The compression information 61 includes the device number of the storage device 51 (“device number 61A”), the LBAs of the logical blocks specified by a corresponding data return command (“LBA 61B”), the data lengths after compression of the database data stored in the logical blocks of the LBAs (“post-compression data length 61C”), and the data lengths before compression of the database data (“pre-compression data length 61D”).

Thus, when the compression information 61 is sent from the storage device 51, the I/O processing circuit 20 secures storage areas of necessary capacities on the memory 17 on the basis of the compression information 61, and gives an instruction to the storage device 51 to write data in the storage region.

When given this instruction, the storage device 51 writes the data stored in the logical block specified in the data read command into the storage areas specified as described above in the memory 17 of the accelerator 14 (S57), and then transmits a read completion notification to the I/O processing circuit 20 (S58).

Then, in the worker node server 50 of the present embodiment, steps S59 to S69 are executed similarly as steps S18 to S28 in FIG. 7.

As described above, in the worker node server 50 of the present embodiment, since the database data is compressed in the storage device 51 and the compressed data is transferred to the accelerator 14 in a compressed state, the same effect as that of the first embodiment can be obtained. In addition, in the present embodiment, since the storage device 51 compresses the database data acquired from the data source DS, the host CPU 10 can be released from the load related to the compression processing, and the processing capability of the host CPU 10 can be distributed to other processing accordingly. Thus, according to the present embodiment, it is possible to realize a worker node server 50 having higher processing capability than the first embodiment.

### (3) Other Embodiments

Although the first and second embodiments described above describe a case where the invention is applied to the worker node servers 7 of the distributed database system 4, the invention is not limited thereto, and can be widely applied to various other information processing devices on which an accelerator is mounted. In this case, the processing executed in the accelerator may be a processing other than filter processing and aggregation processing.

Although the first and second embodiments described above describe a case where the decompression circuit 26 is configured as a part of the I/O processing circuit 20, the invention is not limited thereto, and the decompression circuit 26 and the I/O processing circuit 20 may be configured physically separately.

Further, although the first and second embodiments described above describe a case where the function of the host control unit of requesting the accelerator 14 to execute filter processing, etc. included in the task requested from the outside is mounted on the host CPU 10, the invention is not limited thereto, and a circuit having a function as the host control unit may be provided physically separately from the host CPU 10.

### INDUSTRIAL APPLICABILITY

The invention can be widely applied to an information processing device having various configurations in which an accelerator for executing predetermined processing on data is mounted.

### Reference Sign List

1 information processing system
2 client
3 application server
4 distributed database system
6 master node server
7, 50 worker node server
10 host CPU
11 main storage device
12, 51 storage device
14 accelerator
16 FPGA
17 memory
20 I/O processing circuit
21 filter processing circuit
22 aggregation processing circuit
26 decompression circuit
38 file storage location management table
39 compression information management table
40, 60 processing command
52 controller

1. An information processing device mounted with an accelerator that executes predetermined processing on data, the information processing device comprising:
a storage device configured to store data; and
a host control unit configured to request the accelerator to execute the predetermined processing included in a task requested from an outside,
wherein the data is compressed and stored in the storage device, and
wherein the accelerator:
reads the data to be processed among the data stored in the storage device and executes the predetermined processing on the data while decompressing the read data in response to a request from the host control unit.

2. The information processing device according to claim 1,
wherein the accelerator includes:
an input/output circuit configured to input and output data from and to the accelerator;
a decompression circuit configured to decompress compressed data;
a processing circuit configured to execute the predetermined processing; and
a memory configured to store data,
wherein the input/output circuit:
reads the data to be processed from the storage device and stores the data in the memory in response to a request from the host control unit,
wherein the decompression circuit:
decompresses and transfers to the processing circuit the data to be processed stored in the memory,
wherein the processing circuit:
executes the predetermined processing on the decompressed data transferred from the decompression circuit, and stores a processing result of the predetermined processing in the memory, and
wherein the input/output circuit:
transmits the processing result of the predetermined processing stored in the memory to the host control unit.

3. The information processing device according to claim 2,
wherein the host control unit:
compresses and stores in the storage device the data acquired from the outside.

4. The information processing device according to claim 3,
wherein the host control unit:
notifies the input/output circuit of the accelerator of each data length after compression of the data to be processed when the accelerator is requested to execute the predetermined processing, and
wherein the input/output circuit:
secures storage areas of necessary capacities on the memory in accordance with the data lengths after compression of the data notified from the host control unit.

5. The information processing device according to claim 2, further comprising:
a communication device configured to acquire the data from an external data source and to transfer the data to the storage device,
wherein the storage device includes:
a storage device configured to provide a storage area; and
a controller configured to control read and write of data from and to the storage device, and
wherein the controller:
compresses the data transferred from the communication device and stores the data in the storage device.

6. The information processing device according to claim 5,
wherein the controller:
notifies the input/output circuit of the accelerator of data lengths after compression of the data to be processed when the input/output circuit reads the data, and
wherein the input/output circuit:
secures storage areas of necessary capacities on the memory in accordance with the data lengths of the data after compression notified from the controller.

7. An information processing method executed on an information processing device mounted with an accelerator that executes predetermined processing on data,
the information processing device including:
a storage device configured to store data; and
a host control unit configured to request the accelerator to execute the predetermined processing included in a task requested from an outside,
the information processing method comprising:
a first step of compressing and storing in the storage device the data; and
a second step of, by the accelerator, reading the data to be processed among the data stored in the storage device and executing the predetermined processing on the data while decompressing the read data in response to a request from the host control unit.

8. The information processing method according to claim 7,
wherein the accelerator includes:
an input/output circuit configured to input and output data from and to the accelerator;
a decompression circuit configured to decompress the compressed data;
a processing circuit configured to execute the predetermined processing; and
a memory configured to store data,
wherein in the second step:
the input/output circuit reads the data to be processed from the storage device and stores the data in the memory in response to a request from the host control unit;
the decompression circuit decompresses and transfers to the processing circuit the data to be processed stored in the memory;
the processing circuit executes the predetermined processing on the decompressed data transferred from the decompression circuit, and stores a processing result of the predetermined processing in the memory; and
the input/output circuit transmits the processing result of the predetermined processing stored in the memory to the host control unit.

9. The information processing method according to claim 8,
wherein in the first step:
the host control unit compresses and stores in the storage device the data acquired from the outside.

10. The information processing method according to claim 9,
wherein the host control unit:
notifies the input/output circuit of the accelerator of each data length after compression of the data to be processed when the accelerator is requested to execute the predetermined processing, and
wherein in the second step, the input/output circuit:
secures storage areas of necessary capacities on the memory in accordance with the data lengths of the data after compression notified from the host control unit.

11. The information processing method according to claim 8,
wherein the information processing device further includes:
a communication device configured to acquire the data from an external data source and to transfer the data to the storage device,
wherein the storage device includes:
a storage device configured to provide a storage area; and
a controller configured to control read and write of data from and to the storage device, and
wherein in the first step, the controller:
compresses the data transferred from the communication device and stores the data in the storage device.

12. The information processing method according to claim 11,
wherein in the second step,
the controller:
notifies the input/output circuit of the accelerator of data lengths after compression of the data to be processed when the input/output circuit reads the data, and
the input/output circuit:
secures storage areas of capacities necessary for processing on the memory in accordance with the data lengths of the data after compression notified from the controller.

13. An information processing device comprising:
a storage device configured to store data;
an accelerator configured to execute predetermined processing on data; and
a host control unit configured to request the accelerator to execute the predetermined processing included in a task requested from an outside,
wherein the data is compressed and stored in the storage device,
wherein the accelerator includes:
an input/output circuit configured to input and output data from and to the accelerator;
a decompression circuit configured to decompress the compressed data;
a processing circuit configured to execute the predetermined processing; and
a memory configured to store data,
wherein the input/output circuit:
reads the data to be processed from the storage device and stores the data in the memory in response to a request from the host control unit,
wherein the decompression circuit:
decompresses and transfers to the processing circuit the data to be processed stored in the memory,
wherein the processing circuit:
executes the predetermined processing on the decompressed data transferred from the decompression circuit, and stores a processing result of the predetermined processing in the memory, and
wherein the input/output circuit:
transmits the processing result of the predetermined processing stored in the memory to the host control unit.
